(19) United States
(12) Patent Application Publication
(10) Pub. No.: US 2009/0182659 A1
(43) Pub. Date: Jul. 16, 2009

(54) Method of selling using auction style bidding

(76) Inventor: Philip James Clarke, Harrow (GB)

Correspondence Address: Philip Clarke, Flat 14 Hampden Court, Hide Road, Harrow, HA1 4SL, GB

(21) Appl. No.: 12/015,388

(22) Filed: Jan. 16, 2008

(51) Int. Cl. G06Q 30/00

(52) U.S. Cl. 705/37

(57) ABSTRACT

The invention relates to an auction like bidding process establishing the value of an asset; the sale of the asset going to whomever pays first. This differs from the established auction protocol where the seller is obliged to pass the asset to the highest bidder. With this method, the seller's contractual obligation does not limit the seller to transferring ownership rights to the participants in the bidding process.

### BACKGROUND OF THE INVENTION

From the definition of an auction, a contract exists that the seller will pass the item to the highest bidder. The flaw being that the highest bidder may not have the funds available immediately to the seller, who could then incur extra cost such as storage.

It is feasible to locate prior art where an individual sold an item to the person that paid first and not to the highest bidder, the case being that the individual broke the auction rules and that the auction was not run using this methodology.

### BRIEF SUMMARY OF THE INVENTION

This method makes use of an explicit contract whereby the item will be sold to whomever pays for the item at a price equal to the highest “accepted bid” (in the case of a Vickrey auction the highest “accepted bid” is the value of second highest bid); regardless of whether they participated in the bidding process. The bidding process existing to determine a price for the item.

Fundamental to the definition of an auction is the obligation that the item is sold to the highest bidder, therefore this method could not be classified as an auction. It takes the advantage of the auction bidding format in assigning a monetary or other such value to an item and incentivizes the winning “bidder” to pay for the item as quickly as possible. The contract of sale is altered, from being the established auction format between the highest bidder and the seller; to be between the seller and person prepared both to pay the “accepted bid” price and can pay the quickest.

### DETAILED DESCRIPTION OF THE INVENTION

Drawing from auction definitions, the bidding process for this sales method can be established. An example “sealed bid first price” auction could be take place where bidders submit their highest bid sealed in an envelope. The bids would be published, with the highest establishing the item's price, the losing bidders then still have a chance to pay as the seller will transfer the ownership of the item to the person that pays first.

An “English auction”, whereby the bidding period is extended until there are no more bids, is a little more complex to arrange the method of payment. It is feasible that “cash in hand” could beat “payment by cheque” or that “money on deposit” with a “bidding house” could beat an “electronic transfer of funds”. The prioritizing of methods of payment over one another, or the acceptance of only one agreed upon type of payment being necessary for the methodology to work. The accepted payments could be limited to cash only, in which case it would be a matter of whomever counted the funds out first, or limiting the payment method to an electronic transfer of funds, could result in an on-line sale with the winner being the first to click on a button or link.

The winning bidder has an advantage in that they know the amount bid and should have those funds to hand, the losing bidders must digest that information, assess whether they are prepared to pay the extra, before completing the transaction.

An auction that finishes at a specified time is very amenable to this system, where bidders tend to place their highest bids at the last moment. The losing bidders still have a second chance to buy the item at the higher price before the winning bidder completes their transaction. This differs from the current “second chance offer” in that in this system the contractual obligation to sell to the highest bidder no longer exists and promotes quick transfers of funds to the seller.

Accepting an offer on a item that is for sale differs from this system as the price is established by the seller rather than by the probing of what the maximum amount the market is prepared to pay for an item by using a bidding system.

### EXAMPLE SCENARIOS

For these examples, it is assumed that there is a bidding period that establishes an item's value at £100 and has ended. Bidder A was prepared to pay £90 and bidder B placed the £100 bid.
1. Bidder B can only transfer funds by cheque requiring 5 working days, while bidder A reconsiders the value of the item and decides that he is prepared to pay £100 by bank transfer. Bidder A transfers the money to the seller and the item is marked as sold. B was the winner of the bidding but “lost” because he could not provide the funds as quickly as A.
2. Bidder B is able to pay by electronic transfer of funds, but an observer C steps in and places £100 cash in the sellers hands. C takes possession of the item.
3. Bidder A decides that he would like the item at the final price, both bidder A and bidder B have the same ability to transfer funds by direct transfer and it becomes a competition to see who can transfer the funds first, either A or B can win the item although B has a cognitive advantage in that he can specify the amount to be transferred immediately as he already knows what his maximum price is.

There are clearly defined necessities in the selling scenarios, these being
the contract to sell at a bid price to the person that pays first
the ability to take bids on an item
the closure of the bidding
the disclosure of the item's attained value
the acceptance of funds
the marking of the item as “sold” so that no more funds can be deposited.
the definition by the seller or “bidding house” as to which type of payment takes priority over another.

The method of selling can be run as an extension to an auction house's existing policy of sales by the seller choosing this methodology as an option. Payment can be by transfer of funds, a credit arrangement, transfer of assets, and the “item for sale” could be a legal contract such as a rental period or patent rights: The “item for sale” may not physically exist. The “payment” for the item is not be limited to a monetary value, and may also be a transfer of other assets such as shares in a company in exchange for the sold item. The established value of the item may not be the highest bid, as it depends on the rules of the bidding process and could be a Vickrey style auction as mentioned previously or a Dutch style auction where the lowest value is accepted. The type of bidding process e.g. English Auction, must be established within the framework of the sale so that the contract of sale between seller and bidder can be completed.

I claim:

1. A method of selling assets where said method comprises of finalising the value of the asset by bidding, with the sale, rental or licence of the asset to the first person, first group or first legal entity who pays for the asset after the bidding has closed.
